(19) United States
(12) Patent Application Publication
(10) Pub. No.: US 2011/0225069 A1
(43) Pub. Date: Sep. 15, 2011

(54) Purchase and Delivery of Goods and Services, and Payment Gateway in An Augmented Reality-Enabled Distribution Network

(76) Inventors: Donald M. CRAMER, Ostrander, OH (US); David A. ELCHONESS, Niwot, CO (US); Angus C. SHEE, Boulder, CO (US)

(21) Appl. No.: 13/045,860

(22) Filed: Mar. 11, 2011

Related U.S. Application Data
(60) Provisional application No. 61/313,244, filed on Mar. 12, 2010.

(51) Int. Cl. G06Q 30/00

(52) U.S. Cl. 705/27.1; 705/26.1

(57) ABSTRACT

The present invention relates to systems and methods for purchasing goods and services in an augmented reality-enabled distribution network. The system includes a server supporting the presentation of information within augmented reality of a plurality of participants. A communication network is included for facilitating the transfer of information from the server to devices of the plurality of participants. Also included is a purchase and delivery exchange that facilitates the sale of goods and services deliverable through augmented reality. In addition, a payment gateway facilitates the transfer of funds between a buyer and seller in association with a transaction conducted through the purchase and delivery exchange.

### CROSS REFERENCE TO RELATED APPLICATIONS

The present application claims priority to and the benefit of U.S. Provisional Application No. 61/313,244, entitled “Purchase and Delivery of Goods and Services, and Payment Gateway in an Augmented Reality-Enabled Distribution Network,” filed on Mar. 12, 2010, which is herein incorporated by reference in its entirety.

### BACKGROUND

1. Field

The present invention relates to augmented reality.

2. Relevant Technology

Augmented Reality (AR) is a technology that enables digital data to be displayed as an information layer over a live view.

### SUMMARY

It is to be understood that the present invention includes a variety of different versions or embodiments, and this Summary is not meant to be limiting or all-inclusive. This Summary provides some general descriptions of some of the embodiments, but may also include some more specific descriptions of other embodiments.

The present invention relates to systems and methods for making purchases in an augmented reality.

In one embodiment, a computer implemented method provides for purchases in an augmented reality. An augmented reality is provided to a participant with the augmented reality including a smart marker representing an exchange and the smart marker having an interactive zone. A notification is received that the participant is within the interactive zone. A notification is provided to the participant indicating the presence of the exchange. In some embodiments. A request is received from the participant for a purchase of an item within the exchange. The purchase of the item is facilitated through a payment gateway. The item within the exchange may be a physical good, a physical service, a virtual good, and a virtual service.

In some embodiments an input is received indicating a selection of said smart marker and information is provided to the participant relating an item available for purchase within the exchange.

In some embodiments, an input is received indicating a selection of the smart marker and information is provided to the participant relating a means for accessing said exchange. In one embodiment, the means includes providing a uniform resource locator.

In some embodiments, the smart marker is located within the augmented reality at a location corresponding to a physical location of a merchant.

In some embodiments, the exchange includes items sold by the merchant outside of the augmented reality. The smart marker may be located within the augmented reality at a location corresponding to a point of interest. The exchange may contain items related to the point of interest. The items related to the point of interest may be provided by a plurality of merchants.

In another embodiment, one or more computer readable storage media store computer executable instructions that, when executed by one or more computing processors of a computing system, cause the computing system to perform a method for making purchases in an augmented reality. An augmented reality is provided to a participant with the augmented reality including a smart marker representing an exchange and the smart marker having an interactive zone. A notification is received that the participant is within the interactive zone. A notification is provided to the participant indicating the presence of the exchange. In some embodiments, a request is received from the participant for a purchase of an item within the exchange. The purchase of the item is facilitated through a payment gateway.

In another embodiment, a computer implemented method makes purchases in an augmented reality. In the computer implemented method a location of a user is determined. An augmented reality is displayed with the augmented reality based on the location of the user and including a smart marker representing an exchange. The smart marker being associated with the location of the user. A user input is received indicating the selection of the smart marker and information associated with the exchange is displayed to the user. In some embodiments, the information includes a list of items available at the exchange.

In some embodiments, a user input is received selecting an item from among the list of items available at the exchange. The purchase of the item is then facilitated through a payment gateway. The item may be a physical good, virtual good, physical service, or a virtual service.

In another embodiment, one or more computer readable storage media store computer executable instructions that, when executed by one or more computing processors of a computing system, cause the computing system to perform a method for making purchases in an augmented reality. In the method a location of a user is determined. An augmented reality is displayed with the augmented reality based on the location of the user and including a smart marker representing an exchange. The smart marker being associated with the location of the user. A user input is received indicating the selection of the smart marker and information associated with the exchange is displayed to the user. In some embodiments, the information includes a list of items available at the exchange. A user input is received selecting an item from among the list of items available at the exchange. The purchase of the item is then facilitated through a payment gateway.

In another embodiment, a system for making purchases in augmented reality is disclosed. The system includes a server supporting the presentation of information within augmented reality of a plurality of participants. A communication network is included for facilitating the transfer of information from said server to devices of said plurality of participants. The system further includes a purchase and delivery exchange facilitating the sale of goods and services deliverable through augmented reality.

In some embodiments the system for making purchases in augmented reality includes a payment gateway facilitating the transfer of funds between a buyer and seller in association with a transaction conducted through the purchase and delivery exchange.

In another embodiment another system for making purchases in augmented reality is disclosed. The system includes a server supporting the presentation of information within augmented reality of a plurality of participants. A communication network is included for facilitating the transfer of information from the server to devices of the plurality of participants. The system further includes a smart marker facilitating the sale of a good or service deliverable through augmented reality.

In some embodiments the system includes a payment gateway facilitating the transfer of funds between a buyer and seller in association with the purchase of said good or service.

Various components are referred to herein as “operably associated.” As used herein, “operably associated” refers to components that are linked together in operable fashion, and encompasses embodiments in which components are linked directly, as well as embodiments in which additional components are placed between the two linked components. As used herein, the term “detachably-attached” means temporarily attached, and “detachably-attachable” means adapted to be temporarily attached.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are understood by those of ordinary skill in the art to encompass obvious improvements and modifications thereto.

Additional advantages of the present invention will become readily apparent from the following discussion, particularly when taken together with the accompanying drawings

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a scalable and distributed augmented reality network and platform that supports the implementation of augmented reality to a plurality of users, in accordance with one embodiment of the present invention.

FIG. 2 is an illustration of an exemplary user interface on a display showing a view of augmented reality for a user, in accordance with one embodiment of the present invention.

FIG. 3 is an illustration of an exchange for facilitating the transaction of goods and services, virtual or real, between buyers and sellers as implemented within an augmented reality distribution network, in accordance with one embodiment of the present invention.

FIG. 4 is an illustration of an exemplary user interface on a display showing a view of augmented reality for a user and various types of smart markers, in accordance with one embodiment of the present invention.

FIG. 5 provides an illustration of a smart marker locator pointing to the right, in accordance with one embodiment of the present invention.

FIG. 6 provides a flow diagram illustrating a method for providing purchases in a augmented reality.

FIG. 7 provides a flow diagram illustrating a method for making purchases in an augmented reality environment.

### DETAILED DESCRIPTION

Reference will now be made in more detail to the preferred embodiments of the present invention, systems and methods for the purchase and delivery of goods and services, virtual and real, and a payment gateway in an augmented reality distribution network in an augmented reality-enabled distribution network. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention.

Accordingly, embodiments of the present invention exist within a distributed augmented reality-enabled network. Also, other embodiments of the present invention provide the above advantages and also provide for a mobile interface that seamlessly integrates augmented reality with the immense functionality available on mobile devices. The result is an entertaining, information-rich experience which makes every media type immediately available. Embodiments of the present invention effectively utilized location-enabled triggers and content from the user's environment offering interaction with surroundings and peers in a unique and novel manner.

### Notation and Nomenclature

Embodiments of the present invention can be implemented on a software program for processing data through a computer system. The computer system can be a personal computer, notebook computer, server computer, mainframe, networked computer (e.g., router), handheld computer, personal digital assistant, workstation, and the like. Other embodiments may be implemented through specialized hardware that is activated by a signal generated by the process that provides for the purchase, payment, and delivery of goods and services. This program or its corresponding hardware implementation is operable for the purchase and delivery of goods and services, and a payment gateway in an augmented reality distribution network. In one embodiment, the computer system includes a processor coupled to a bus and memory storage coupled to the bus. The memory storage can be volatile or non-volatile and can include removable storage media. The computer can also include a display, provision for data input and output, etc.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “providing,” and “facilitating,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### Smart Markers Within Augmented Reality

Augmented reality (AR) blends computer generated imagery with a representation of a physical, real-world environment, and more particularly, enables digital data to be displayed as an information layer over a live view. For instance, one particular augmented reality may be associated with the live camera view of a mobile device corresponding to a user. As such, the user is presented with an individualized view of augmented reality through the live camera view.

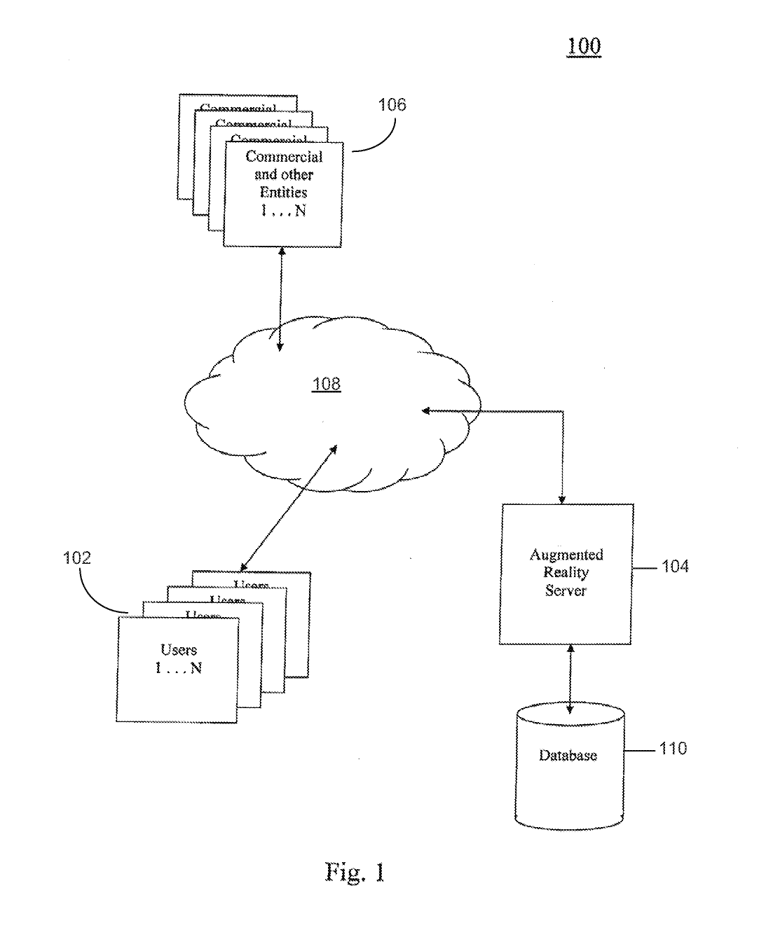

FIG. 1 is an illustration of a scalable and distributed augmented reality distribution network and platform 100 that supports the implementation of augmented reality to a plurality of users 102, in accordance with one embodiment of the present invention. In particular, an augmented reality server 104 is shown that creates and supports the augmented realities of a plurality of users 102, a plurality of commercial entities 106, and a plurality of other entities, where the plurality of augmented realities is presented on associated user devices (e.g., mobile devices, goggles, computer platforms, etc.). As such, the augmented reality server 104 is capable of presenting information overlaid on or in corresponding representations of real views for each of the plurality of users 102 and/or entities 106. Of course, the augmented reality server 104 as represented in FIG. 1 could be supported by one or more physical servers distributed throughout a communication network 108 in one or more locations.

In one embodiment, the augmented reality server 104 is capable of supporting one or more presentations of augmented realities through mobile AR platforms existing on one or more mobile devices. More particularly, the augmented reality server 104 is capable of interfacing and communicating with the AR platforms of the mobile devices so that a corresponding AR platform is able to present an appropriate augmented reality that relies on a representation of the real, live view of the world through a corresponding mobile device. Specifically, the AR platforms are capable of communicating with the augmented reality server 104 to access appropriate information that is to be displayed within a corresponding augmented reality.

For example, a mobile AR platform utilizes global positioning satellites (GPS), compass, accelerometer, and other location/position/orientation device information to display a vivid augmented reality in the camera-view of a corresponding mobile device (e.g., mobile phones). As such, the AR platform utilizes a mobile device camera or other live imaging device (goggles, etc) equipped with location technology (GPS, Wi-Fi, RFID, sensor technology, etc), compass, and accelerometer, such that one or more smart markers appears over the live view at specified coordinates.

The augmented reality server 104 functionality may be accessed by users and/or entities through any communication means. For instance, the augmented reality server 104 may be accessed through the internet, telephone communication networks, wireless communication networks, etc. Access to the augmented reality server 104 is available to manage and establish accounts, as well as utilize other features of the augmented reality network, as will be described below.

Additionally, the augmented reality server 104 is associated with a database 110. The database 110 includes information relating to profiles of corresponding users 102 and entities 106, such as name, address, and various demographic information, as well as other types of information suitable for use within the augmented reality network. This profile information is useful in managing the pluralities of users 102 and entities 106 throughout the augmented reality network.

Further, the database 110 includes information associated with the users 102 and entities 106 that is displayed or accessible in corresponding augmented realities. For instance, the term “smart marker” is used herein to represent information that is available through the augmented reality network. A smart marker enables the display and management of information in digital space that is overlaid on real-world locations. In particular, a smart marker is layered over a particular real view, to form, in part, a corresponding augmented reality view. For instance, the smart marker may appear as a digital representation (e.g., icon, three dimensional [3D] object, image, etc.) within a corresponding augmented reality at user specified coordinates in the real world. As such, the augmented reality network and platforms enable users 102 (individuals, groups, stores, corporations, and other entities) to create their own geo-located AR smart markers at any location in the physical world.

In addition, smart markers can be associated with fixed locations, or with mobile objects that are associated with inventory or individuals (e.g., mobile devices, radio frequency identifications (RFIDs), etc.) whose smart marker positions update as the related objects move. For instance, a smart marker may be associated with a physical, retail store that is a brick-and-mortar store located at a physical location having coordinates. By selecting the smart marker, additional information, relating to the retail store, can be accessed through the augmented reality platform as supported by the augmented reality server. Also, a smart marker can be associated with a mobile object, such that as the physical location of the object moves, the corresponding smart marker's location within a representation of the real world also moves. As such, the smart marker can be used to represent the moving object in real space, and to provide access to information that is related to the moving object.

Within the augmented reality network, as supported by the augmented reality server 104, users 102 and/or entities 106 create accounts and place smart markers at user-designated locations throughout the world using a network supported mobile application or a network supported integrated website.

In some embodiments, from a mobile application or platform, a user can assign coordinates representing a physical location as a smart marker location. The coordinates may correspond to the actual location of the user, at the time the coordinates are assigned, or may correspond to another physical location separate from the location of the user. In addition, the user is able to select from nearby businesses or landmarks that they can designate as a smart marker location. From the website application or platform, users can click and drop smart markers on a dynamic map, enter a known address, or search for known businesses or landmarks to assign as a marker's location. In both cases, multimedia files (photos, video, audio, text, etc.), links, other types of information, actions, etc., can be attached to smart markers using either the mobile application or the website.

In some embodiments, these multimedia files can be the actual digital representation of the smart marker within the augmented reality view. For example, a smart marker may be a picture of a building that a user would view within the augmented reality view at the marker's location. Triggering the multimedia files can occur by user input such as clicking the smart marker or interacting with overlaid media controls, or done automatically based on proximity of the user to the location represented by the marker. For example, as the user approaches a location represented by a smart marker having a video, the video is triggered to automatically begin playing once the user crosses a physical boundary related to the location, or when the smart marker appears within the user's augmented reality view on the mobile device.

For example, one or more actions assigned to a smart marker include, but are not limited to the following: calling a phone number; texting a number; sending an e-mail; viewing text; viewing a website; viewing multimedia—photos, video, audio, etc.; getting directions to the smart marker; commenting on the smart marker; sending the location to another user; and posting the smart marker to social networks.

Each smart marker may contain a collectible digital item that a user can acquire. This digital item can represent and contain a unique content and location of the marker. Access to the collectible digital item can be controlled based on the smart markers creator. For example, the collectible digital item may be accessible only when the user is in a predetermined physical proximity to the location represented by the marker, or the collectible digital item could be accessed using a key, such as a password, found at the physical location represented by the marker.

The user can collect the digital item, customize it by adding the user's own content such as text, photo, multimedia, video, audio, etc and share the digital item. The user may share the item to their social networks, or may send an electronic communication to another user containing a reference to the digital item, or the digital item itself In some embodiments the user may create a new smart marker and associate the digital content with the new marker.

The history of all the digital items that the user has collected can be accessed and edited using a view that may be sorted by any number of ways including date, location, alphabetically, favorites, etc. The digital items may also be accessed and edited in the augmented reality view based on where the digital items were originally collected, or where the digital items were left by the user.

In some embodiments, users who receive these digital items from other users can access all of the content and actions contained within each digital item, as well as interact with the digital item and the smart marker that it originated from. For example, users can collect digital “postcards” of smart markers all around the world. The postcards tell unique stories about the locations where the smart markers are dropped. Users can attach photos of themselves at these locations to the postcard and share them with all of their friends through social networks or traditional means like e-mail or SMS or MMS. Someone who receives this postcard can see the content contained within the postcard, access actions that were associated with the smart marker that the postcards originated from, including but not limited to getting directions to the marker, saving the smart marker location to their mobile device, or saving the content of the postcard or smart marker for their own future use.

Further, smart markers can be accessed in a number of different ways, in various embodiments. For instance, one or more smart markers are accessible through a corresponding view of augmented reality. In addition, one or more smart markers are accessible through a “Map View” that utilizes a two dimensional (2D) map, where a smart marker may be displayed relative to the user's location. Also, one or more smart markers are accessible through a “List View” that lists all smart markers within a specified range of the user. Further, a “Hybrid View” overlays a map view on the augmented reality view to display smart markers with more intuitive depth perception. This Hybrid View may include a combination of the foregoing views.

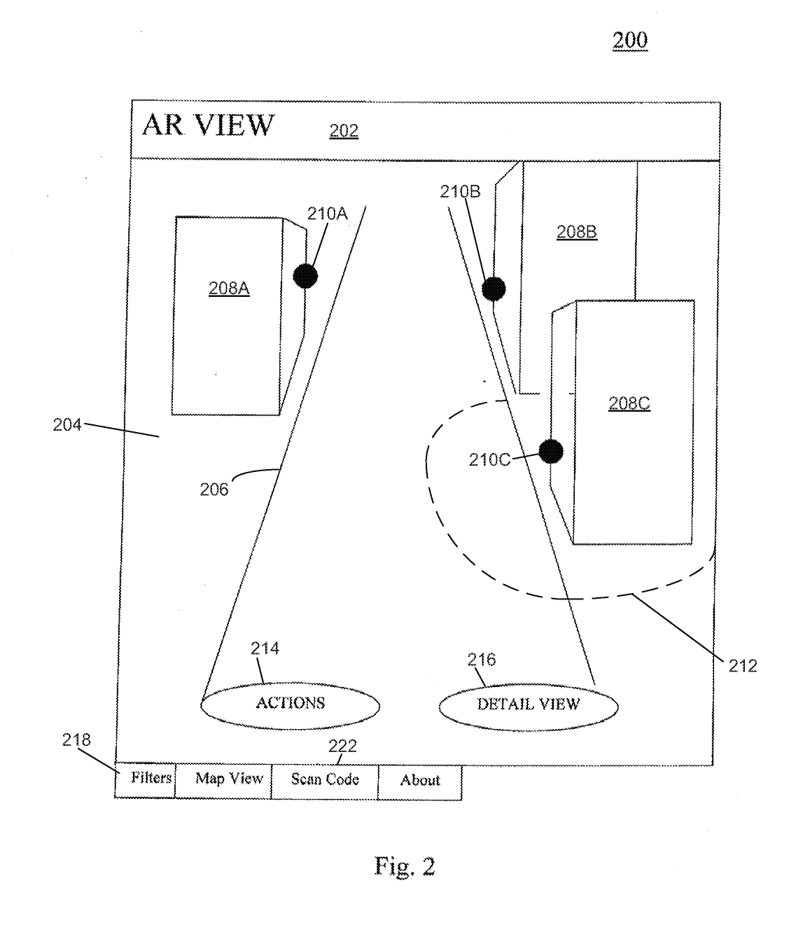

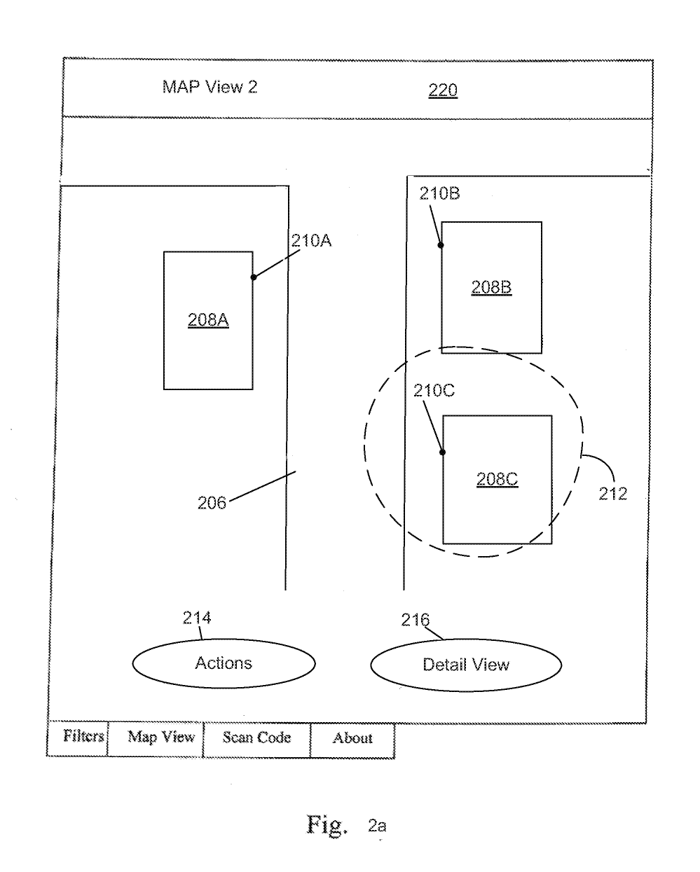

FIG. 2 is an illustration of an exemplary user interface 200 on a display showing an augmented reality view 202 for a user, in accordance with one embodiment of the present invention. As illustrated, a real and live view 204 down the middle of a street 206 is displayed. Buildings 208A, 208B, 208C are also shown on both sides of the street 206. The real, live view 204 may be from a camera of a mobile device, with the user holding the mobile device pointed down the middle of the street 206. Other live image devices may be used and supported by the augmented reality server 104, such as goggles, etc. The live view 204 is updated utilizing location, accelerometer, compass, and other orientation devices. Information is overlaid the real, live view 204 to create an augmented reality for the user using customizable mobile platform providing augmented reality enabled applications.

For instance, smart markers 210A, 210B, 210C are shown located next to the buildings 208A, 208B, 208C. Smart markers 210A, 210B, 210C can be any digital representation, such as an icon, 3D object, image, or any customizable icon, etc. that corresponds to a position within real space, and corresponding space in augmented reality. Smart markers 210A, 210B, 210C may be associated with a business (retail store, professional service, restaurant, etc.) located in a corresponding building such as smart marker 210A at building 208A, and appears at specified coordinates in the live view.

Smart markers 210A, 210B, 210C may be accessed in various ways to access information provided by the augmented reality server 104, or the AR platform on the mobile device. For instance, smart markers 210A, 210B, 210C may be accessed by clicking, either through a touch screen, or through physical buttons on the mobile device. Since the locations represented by the smart markers 210A, 210B, 210C reside in a 3D physical space, smart markers 210A, 210B, 210C that are physically further away from the location of the user, which may be the user's physical location or virtual location, can have visual characteristics that indicate the distance to the distant smart markers relative to smart markers that are closer to the user using factors such as variable size, transparency, shape, height in the view, etc. For example, smart marker 210B could be smaller than smart marker 210C. These visual characteristics allow the user to access the markers within a 3D space in the Y direction as they are used to doing in real life, vs. the Z direction alone as is customary on mobile devices.

Smart markers 210A, 210B, 210C can be manipulated within the augmented reality view 202 to create the appearance of “zooming in” or “zooming out” to let the user access smart markers at different distances from their location. One method of manipulating the 3D space is to variably change the appearance of smart markers 210A, 210B, 210C based on a user action such as swiping up or down on the screen (or other user input like phone rotation, verbal commands, hand gesture, eye movement, etc). In this first example, when a user swipes up on the screen, smart markers 210A, 210B, 210C further away from the user can appear to get closer to the user in the augmented reality view 202. As the user swipes down on the screen, the opposite behavior occurs.

Several methods can be used to make this augmented reality 3D experience feel natural and easy for the user. Smart markers 210A, 210B, 210C that are bunched very close together can often be skipped over due to their proximity in physical space. In these instances, a slower scroll rate or a variable distance between the smart markers 210A, 210B, 210C can be automatically incorporated. The user action of swiping up/down on the screen can also automatically jump to subsequent smart markers at a pre-determined optimal size so that users do not have to control when the best point to stop zooming is. Smart markers 210A, 210B, 210C can also be automatically centered and stabilized in the augmented reality view 202 once the optimal size is achieved to make jumping from smart marker to smart marker a very simple process. As the user moves through space, smart markers 210A, 210B, 210C can automatically update and display at optimal viewing sizes based on the user's location. User actions can also manipulate the behavior of smart markers 210A, 210B, 210C within the augmented reality view 202. For example, swiping left and right on the screen can rotate the smart markers 210A, 210B, 210C in 3D space, or trigger an action like sending a message, or deleting a smart marker.

Passive notifications can let a user know about the presence of smart markers 210A, 210B, 210C in their vicinity based on their preference settings. This can be achieved by defining a customizable zone 212 around a smart marker 210C. When a user enters this zone 212, an action is triggered. This action can be a vibration or audible action from the phone or other device with the augmented reality view 202 to notify the user. Notifications can also be sent to designated persons with interest in the user or the smart marker 210C in question. This can used for tracking purposes or simple notifications.

Smart markers can also inform the user of nearby smart markers that the user may be interested in based on their interaction with the original smart marker. For example, smart marker 210C may identify smart marker 210B and provide visual indicators as to which direction and how far away smart marker 210B are to the user. Traditional map and text turn-by-turn directions can be overlaid in the augmented reality view 202 to supplement visual indicators such as real-time dynamically changing arrows.

Once the smart marker is selected, information (e.g., text, links, video, multimedia, etc.) is available to the user. This information is fully customizable to the creator of the smart marker. For instance, smart marker 210A may correspond to an individual, and thus is displayed at the current location of the individual. Information related to that smart marker 210A may include current information related to that individual, such as current status, whether he or she is available for quick meeting, last update information, etc. In another embodiment, a smart marker, such as smart marker 210B may correspond to a business entity, and is displayed in relation to a physical location of the business. Information related to that smart marker 210B may include current information related to the business, such as address, general information regarding the business, promotions, coupons, etc.

A smart marker may be personalized to the user. That is, a user can create and edit their own smart marker, and place it at any geo-location in real space. For example, smart marker 210A could have been created by the user and would be displayed in the augmented reality view 202 for the user. As examples, a personal smart marker may include personal notes and documentation relating to a landmark. Additionally, the personal smart marker may be shared with others, so that they can view the user's smart marker in their augmented reality.

The “Actions” button 214 provides user access to additional technology. For example, one or more actions assigned to a smart marker include, but are not limited to the following: calling a phone number; creating voice memo, texting a number; sending an e-mail; viewing text; accessing and viewing a website; viewing multimedia—photos, video, audio, etc.; getting directions to the smart marker; commenting on the smart marker; sending the location to another user; and posting the smart marker to social networks.

The “Detail View” button 216 provides additional in-depth details of selected assets relating to the smart marker.

The viewable smart markers 210A, 210B, 210C in augmented reality may be further filtered. As such, the filter option 218 allows a user to display and view only desired smart markers, such as desired categories of smart markers, or filtering using specific search criteria, as supported by the search engine (not shown) in association with the augmented reality server 104. As another example, a filter may designate the range or distance form the user within which smart markers are displayed.

In addition, smart markers 210A, 210B, 210C may be viewed in other views. For instance, as shown in FIG. 2A, smart markers 210A, 210B, 210C may be viewed in map view 220. As such, instead of a view of 3D space in augmented reality as in AR View 202, the map view 220 provides a top down 2D view of space, with smart markers 210A, 210B, 210C located using map coordinates corresponding to specific locations of businesses, landmarks, personal points of interest, etc.

In addition, a scanner may be included. The scan code button 222 enables built in tag reader functionality, such as the ability to process common codes, such as bar codes or quick response (QR) codes, etc. Codes read by the scanner can launch the same behavior as is described for smart markers.

The display showing an augmented reality may include other options. For instance, a legend may be implemented displaying filtering options. The legend may include various categories of smart markers or content categories, such as “Friend,” “Coupon,” “Video,” “Movies,” “Sports,” and “Venue.” Further, these categories, and the corresponding smart markers they are associated with may be color, size, shape-coded, or otherwise identifiable within the augmented reality. The Friend category is related to smart markers of friends of the user. The Coupon category is related to smart markers that provide or are linked to coupon offers. The Video category may be related to smart markers providing video content. And the Venue category may be related to smart markers associated with special venues (e.g., concert hall) or businesses. In this way, a user can quickly distinguish between displayed smart markers 210A, 210B, 210C.

The user can also turn each of these categories on/off directly from the legend in the augmented reality view 202. Turning a category off removes all the smart markers within that category from the augmented reality view 202. The legend can be updated in real-time displaying categories with smart markers nearby or categories marked as “favorites” of the user. As the user physically moves through to a new location, the legend updates based on the new location and the user's preferences. The legend can visually identify which categories are available, which are favorites, and which are turned on. Categories can also be displayed within the legend based on popular categories in the region determined by the number of smart marker views within each category by other users, or by predicted user interests based on the user's previous actions (locations traveled, smart markers viewed, spending habits, etc) or user profile (lifestyle, age, interests, etc). The user can also input a search term that locates all smart markers that fit the search term and return the results from multiple categories in the augmented reality view 202.

A user can also have the ability to prioritize how smart markers appear within each of the categories. Smart markers that a user does not wish to see anymore can be hidden from the augmented reality view 202. Favorite smart markers can be given priority to display over other smart markers in the area.

The display may show a radar view of all smart markers within the general vicinity of the user. For instance, the radar view displays smart markers relative to the user location using 2D radar mapping. As such, smart markers within a general range are shown on the radar map relative to the user's position. In addition, the view of the map may be oriented such that the user directionality is displayed relative to asset or smart marker locations. The view of the map, is updated as the user moves. Additional details and information is displayable. For instance, a coupon may be provided within the display that is associated with a selected smart marker, or may be generally displayed since the user is within the vicinity of the business establishment.

### Purchase and Delivery of Goods and Services in Augmented Reality

A distributed augmented reality distribution network makes possible the purchase and delivery of goods and services to participants in the network, in embodiments of the present invention. As such, a participant may purchase goods and services for his or her personal benefit, or for the benefit of other individuals and entities.

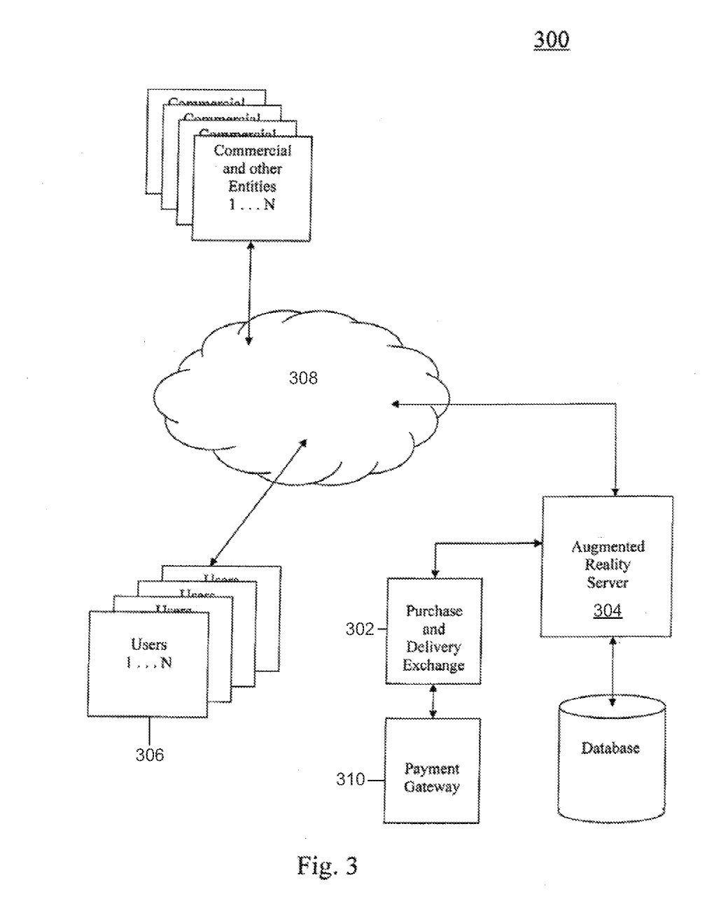

In one embodiment, an exchange 302 for facilitating the transaction of goods and services, virtual or real, between buyers and sellers is implemented within an augmented reality distribution network 300 of FIG. 3. The exchange 302 facilitates the purchase and delivery of the goods and services between the buyers and sellers. As shown, the exchange 302 is supported by or associated with the augmented reality server 304 that creates and supports a plurality of augmented realities of a plurality of participants (e.g., individuals and entities, etc.). The exchange 302 is a virtual store accessible through the augmented reality distribution network 300, such as through mobile devices, in one embodiment. In other embodiments, the exchange 302 is an online store and is accessible through any other communication network, such as the internet.

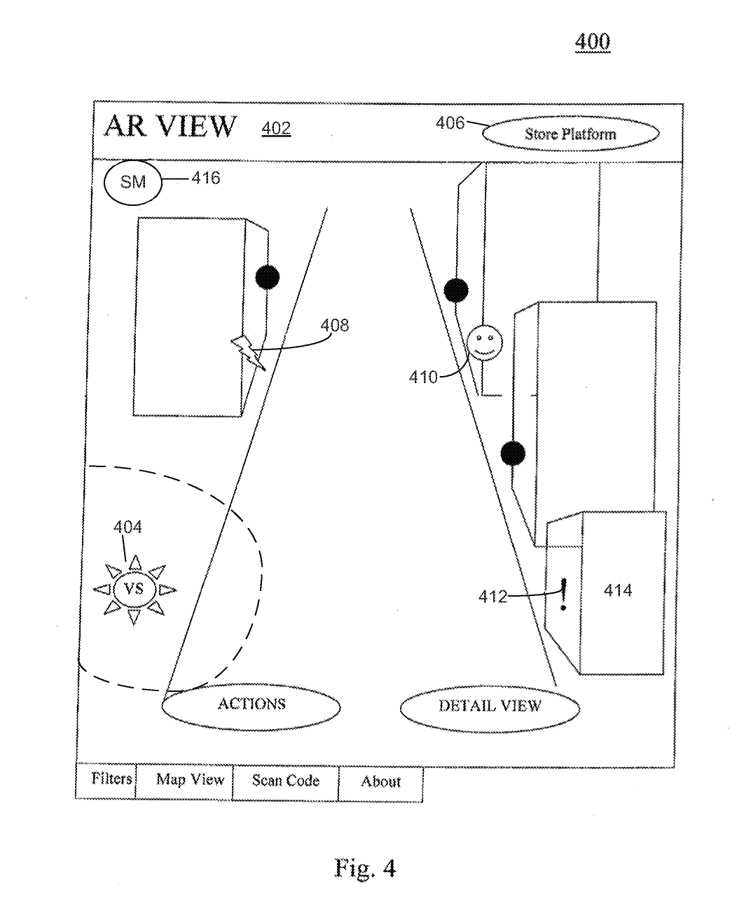

In one embodiment, shown in FIG. 4, the exchange 302 is accessed through an augmented reality view 402. That is, the exchange 302 may be represented as a virtual store, accessible through a smart marker, as presented in augmented reality. In FIG. 4, smart marker 404 represented as a bursting sun symbology, and “VS” text representing a virtual store, presents access to the exchange 302. However, it is important to note that the exchange 302 is independent of any augmented reality. That is, the exchange 302 need not be accessed through any augmented reality view, though the goods and services may be distributed via an augmented reality view, though not necessarily. For instance, also shown in FIG. 4 an icon 406 or button linking to the exchange 302 may be presented on a border or to the side of any augmented reality view 402, on a desktop display providing access to an online exchange 302 via internet, menu page of a mobile device, etc.

More particularly, the exchange 302 facilitates the purchase and delivery of goods and services. In one embodiment, the goods and services are virtual. That is, they are intangible goods and services. In another embodiment, real goods and services are purchased through the exchange 302. Delivery of the real goods and services may also be effected through the exchange 302, in one embodiment, though not necessarily. Throughout this application, unless specifically stated, the use of each of the terms “good,” “goods,” “service,” or “services” is intended to apply both to virtual and real goods or services.

By way of illustration, sellers place the goods and services on the exchange 302 for purchase, in one embodiment. Buyers access the exchange 302 to view and purchase the goods and services. Various types of goods and services are contemplated. For instance, virtual goods and/or services can facilitate access to premium content on the web, music downloads, mobile tickets, coupons, promotions, multimedia, invitations, etc, or even represent the gifting of tangible goods.

For instance, a seller may place on the exchange 302 pre-fabricated custom icons, 3D objects, goods, and services, etc. for users within the network to purchase. As examples, a custom icon may appeal to a buyer for purposes of supplementing his or her user profile, or a smart marker. In one implementation, the icon is used as a personal smart marker within the distributed network of augmented reality, such as the lightning bolt 408 of FIG. 4. As such, when the custom icon appears within an augmented reality view, it indicates that information created by the buyer is available for viewing (e.g., personal note relating to a business, etc.). For instance, the lightning bolt 408 may indicate that the user has personal information relating to the attached business, or a note reflecting on an experience occurring at that geo-location. This additional information, as accessed through the personal smart marker indicated by the lighting bolt 408, is incorporated into a corresponding user profile, in one embodiment.

In another embodiment, the smart marker purchased through the exchange 302 may take on a representation of the user in augmented reality. As such, the lightning bolt 408 represents the user, and as located in augmented reality reflects the physical location of the user in real space.

Also, 3D objects may appeal to a buyer as a virtual good (e.g., birthday cake), or representations of real goods, that in some instances are sent to other users. Still other virtual and real goods may appeal to a buyer, such as virtual gifts, virtual greeting cards(e.g., birthday greetings), coupons, products, data downloads (games, music, etc.).

In one implementation, users can create their own custom virtual goods or services, or representations of real goods or services for upload to the exchange 302 for other users to purchase. In this manner, a dynamic marketplace is effected through the exchange 302 by which users (individuals, entities, etc.) may offer goods and services to other users for purchase.

An example of the purchase of a virtual good is now provided for illustration purposes only. The exchange 302 is able to facilitate the presentation of virtual goods for purchase. For instance, a seller displays a 3D virtual cake, such as a birthday cake, suitable for presentation to another (e.g., recipient) in celebration of an event (e.g., birthday). A buyer views the 3D virtual cake and purchases the item via the exchange 302. A message may be attached, such as “Happy Birthday Recipient from Buyer.” Notification of the gift is effected, such as through a text message indicating a virtual gift is available to the recipient in his or her augmented reality world. In particular, the 3D virtual cake is delivered directly to the recipient via the augmented reality distribution network via a smart marker, in one embodiment. Receipt of the 3D virtual cake is achieved through selection of the smart marker.

Another example describes the purchase of a real good or service, and is described for illustration purposes only. The exchange 302 is able to facilitate the presentation of tangible goods or services for purchase. For instance, in the exchange 302 a seller displays a coupon good for the purchase of large pizza at a pizza establishment (e.g. pizza chain). A buyer views the coupon, and purchases the item via the exchange 302. The coupon may be purchased as a gift that is delivered to a recipient, or for the use by the buyer. If a coupon was purchased as a gift, notification of the gift is effected, such as through a text message to the recipient. The coupon is delivered to the recipient via the augmented reality distribution network via smart marker, in one embodiment. Delivery of the goods and services is described more fully below.

Still another example describes the purchase of an electronic good, and is used for illustration purposes only. The exchange is able to facilitate the presentation of tangible goods in the form of electronic data for purchase. For instance, the exchange is able to display a seller's musical songs, for purchase in electronic form. A buyer views the song, and purchases the song via the exchange. The song may be delivered directly or via a smart marker through a corresponding augmented reality view. If the song was purchased as a gift, then notification is given to the recipient of the gift, such as text message. Receipt of the gift is effected through an augmented reality distribution network via smart marker, in one embodiment. Selection of the smart marker may link the recipient to the business providing music downloads.

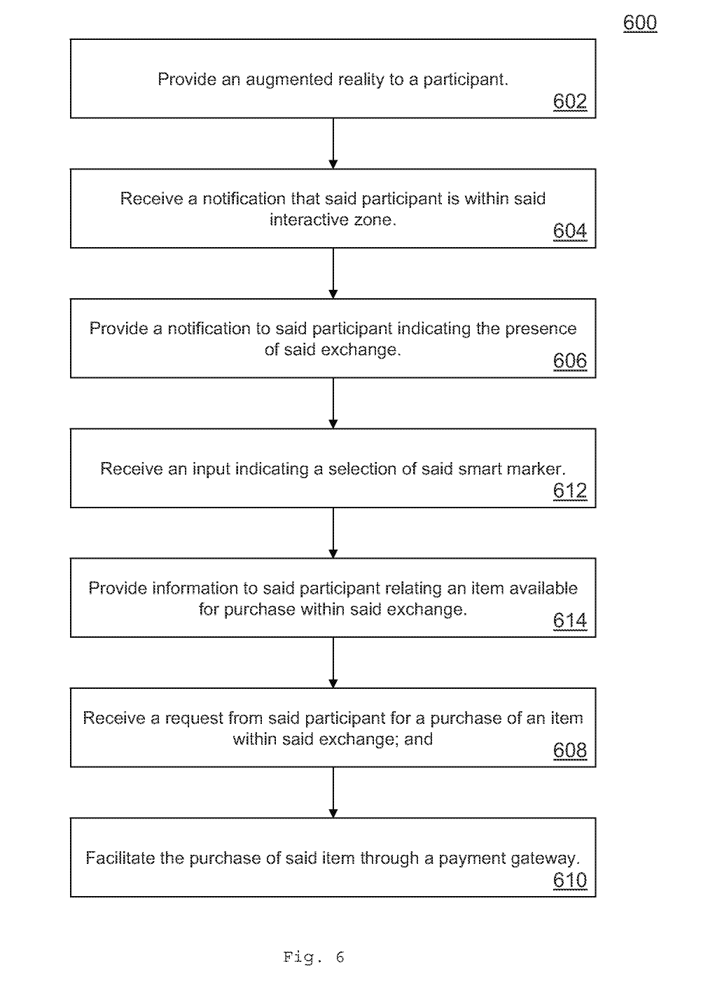

FIG. 6 is a flow diagram illustrating an embodiment of a method 600 for making purchases in an augmented reality. The method will be described in relation to the augmented reality distribution network 300 of FIG. 3. Initially, an augmented reality is provided to a participant 602. For example, augmented reality server 304 may provide augmented reality view 402 to a user. The augmented reality includes a smart marker, such as smart marker 404 representing an exchange, such as exchange 302. The location of the smart marker may correspond to a physical location of a corresponding merchant. In some embodiments, the location of the smart marker may correspond to a physical location of a point of interest. For example, smart marker 404 could be located at a landmark. The smart marker has an interactive zone in which interaction may occur. This interactive zone may be zone 418, or the zone may be the field of view of the augmented reality.

A notification is received indicating that the participant is within the interactive zone 604. For example, augmented reality server 304 may receive a notification through communications network 308.

In response to receiving the notification, a notification is provided to the participant indicating the presence of the exchange 606. For example, augmented reality server 304 may provide a notification to communications network 308 indicating availability of exchange 302. The notification may include instructions to cause the display of the smart marker itself, an animation of the smart marker, or other type of notification as known in the art. For example, augmented reality server could provide smart marker 404 alerting participant 306.

In some embodiments, an input is received indicating a selection of a smart marker 612. For example, augmented reality server 304 may receive an input through communications network 308 that participant 306 has selected smart marker 404.

Information may be provided to the participant relating an item available for purchase with the exchange 614. For example, augmented reality server 304 may provide information to communications network 308 for delivery to participant 306. The information could be a list of items available at exchange 302. The list of items in the exchange could include items normally available at a merchant outside of the augmented reality. For example, a merchant may sell t-shirts in their physical store, and an inventory of the t-shirts selling at the physical store would be provided to the exchange. In other embodiments, information may be provided relating a mean for accessing said exchange. For example, said mean could be providing a uniform resource locator, providing a phone number, or providing a separate application. Other means are possible, as would be recognized by one of skill in the art.

In some embodiments, the items available at the exchange may be related to a point of interest. For example, smart marker 404 could correspond to a home of a historical figure. The exchange may then include items such as books about the historical figure, souvenirs related to the historical figure, and other items that would be of interest to someone at the home of the historical figure. In some embodiments, the exchange may include items from a plurality of merchants.

A request may be received from the participant for the purchase of an item within the exchange 608. For example, augmented reality server 304 may receive a request from communications network 308 indicating participant 302 is purchasing an item from exchange 302. The item could be a physical good, a physical service, a virtual good, and a virtual service.

The purchase of the item is then facilitated through a payment gateway 610. For example, augmented reality server 304 may communicate with exchange 302 and payment gateway 310 to facilitate the purchase of the item.

Method 600 may be implemented by a computer system. The computer system may have one or more computer readable storage media storing instructions, that when executed by a one or more processors of the computing system cause the computing system to perform method 600. For example, augmented reality server 304 may have a storage media with computer executable instructions for implementing method 600. In other embodiments, the computer executable instructions may be stored in a plurality of locations such as augmented reality server 304 and exchange 302. The computer system may include augmented reality system 304, exchange 302, etc.

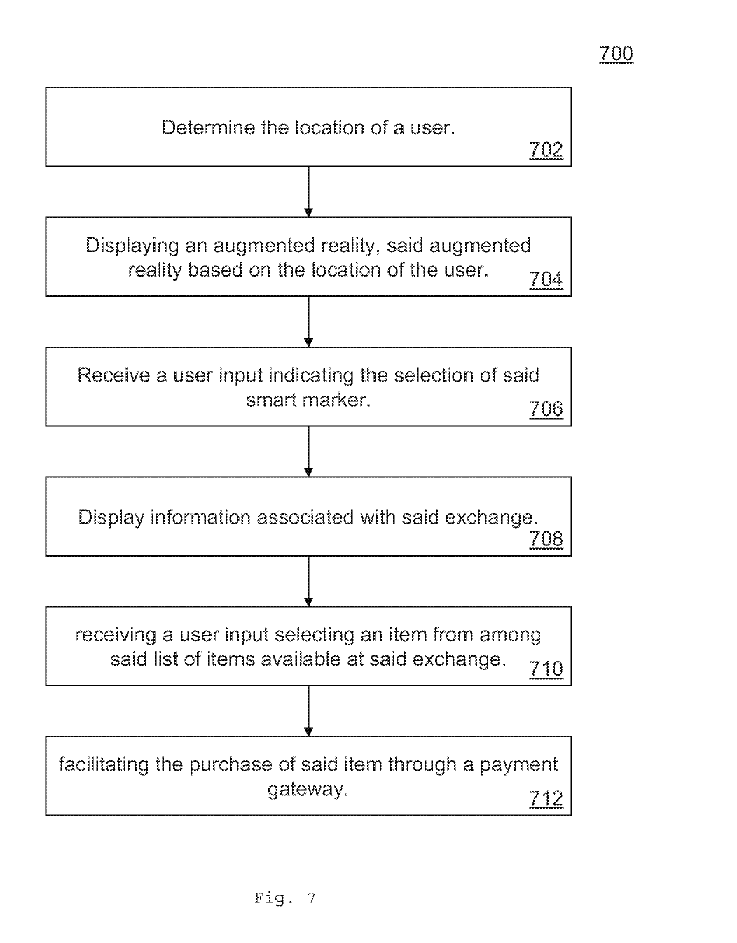

FIG. 7 is a flow diagram illustrating an embodiment of a method 700 for making purchases in augmented reality. The method will be explained with reference to FIG. 4. In the method 700, the location of a user is determined 702. For example, the user could input their location into a personal electronic device, determine a location based on telephone signals, or the device could determine the user's location based on GPS information. The location information is then provided to a server. For example, a personal electronic device could communicate through network 308 to provide location information to augmented reality server 304.

An augmented reality is displayed to the user, the augmented reality being based on the location of the user 704. The augmented reality includes smart markers representing an exchange. For example, user 306 could have a personal electronic device having augmented reality view 402 with smart marker 404.

A user input is then received indicating the selection of the smart marker 706. For example, user 306 could click a button such as 406, or select smart marker 404 in augmented reality view 402. Information associated with the exchange is then displayed to the user 708. For example, a list of items for sale may display in place of augmented reality view 402.

An input may then be received selecting an item from the list of items 710. The purchase of the item is then facilitated through a payment gateway 712. For example, a user may select an item from the list of items displayed on the users personal electronic device. The personal electronic device then facilitates the purchase by communicating with payment gateway 310 through communication network 308.

Method 700 may be implemented by a computer system. The computer system may have one or more computer readable storage media storing instructions, that when executed by a one or more processors of the computing system cause the computing system to perform method 700. For example, a user's personal electronic device may have a storage media with computer executable instructions for implementing method 700. In other embodiments, the computer executable instructions may be stored in a plurality of locations such as augmented reality server 304 and a user's personal electronic device.

### Notification and Delivery of Goods and Services Via Smart Marker

Notification of the availability of a good or service as accessed through augmented reality is provided to a recipient, where the recipient can be purchaser, or the intended beneficiary of a gift. As such, the recipient of the good or service receives notification of the smart marker. The smart marker when selected provides access to the good or service.

Notification can be provided in any manner of communication, and can be effected either through the augmented reality distribution network, or independent of the augmented realty distribution network. For instance, a notification may be provided as a message delivered and received through a user's augmented reality, such as through a pop-up or smart marker notifier. Also, a notification may be provided through a short message service text, a voice mail, email, etc., where the notification is provided independent of the augmented reality distribution network.

The notification includes access information. For instance, the message may indicate that a smart marker is placed within the user's augmented reality. Access to the good or service is provided through the smart marker. There may be further information indicating whether the smart marker is associated with a specific location in augmented reality, or whether it is location neutral. As such, the information indicates where the smart marker may be accessed, the smart marker becomes viewable when the user physically enters a pre-defined range of the location of the smart marker.

Representation of virtual goods and services can be integrated into various aforementioned views of reality as users move through the physical world. For instance, representations of purchased goods and services can be integrated into the augmented reality, map, list, or hybrid views, described previously.

In the case of augmented reality, a smart marker is placed into a corresponding augmented reality view as a representation of the good or service. As shown in FIG. 4, a “happy face” symbol is a smart marker 410 representing a good or service that has been purchased and is available for access. Using the pizza example provided above, the smart marker 410 may indicate a pizza business from which the smart marker 410, as a coupon, can be redeemed for an actual pizza. In addition, using the virtual gift example provided above, the smart marker 410 may indicate a virtual gift that is placed at a location within augmented reality, and is accessible through the smart marker 410.

In a list view, a smart marker that represents the good or service is placed into a list of smart markers available to the user. A hybrid view integrates an isometric view with an augmented reality view to display smart markers with more intuitive depth perception. In all of these cases, selection of the smart marker provides additional information on the good or service, or effects delivery.

In one embodiment, the use of the augmented reality distribution network allows for the display and access of location based goods and services. For instance, smart markers representing geo-specific goods and services become visible and available depending on where the user is geographically located. As an illustration, a smart marker for a good only appears within a one mile radius of a specific location in physical space (e.g., coordinates). That is, the smart marker is assigned to the specific location, and only appears in a user's augmented reality when the user is within the one-mile radius. As such, when the buyer, or recipient in the case of a gift, comes within range, the smart marker becomes visible for selection and presentation of the good. As a result, as the user moves along in augmented reality, smart markers may appear and disappear depending on his or her relation to specific geo-locations.

In all of these cases, proof of purchase of a good or service obtained through the exchange or smart marker can be generated in any suitable manner. In one implementation, an electronic receipt is generated in relation to the purchase of a good or service. The receipt may be generated by the exchange 302 server in the augmented reality distribution network or the business establishment using the augmented reality distribution network to sell the good or service. The electronic receipt may be delivered to the recipient of the good or service, and used to receive the good or service upon tendering the electronic receipt to the business establishment holding the good or service.

In addition, the smart marker may be presented at a particular time and directed to a location that is specified by the purchaser. For instance, if the good as accessed through the smart marker is a gift, then the purchaser may indicate that the smart marker only appear after a certain date and time, and at a specific location. As an example, the smart marker may be made to appear in a recipient's augmented reality after a birthday date and after 10 am, when the recipient is known to be at his or her office. The smart marker is co-located with the office at a specific location.

As such, the good is delivered for pick-up to a specified location as indicated by a smart marker, at a specific time and date. The user is able to access the good at the location specified by the smart marker. In the case of a virtual good, the user is able to view the good. In the case of an actual good, the user is able to pick-up the good at the corresponding business, the location of which is indicated by the smart marker. For example, the user may pick-up a pizza from a pizza establishment. Additionally, once verification of the receipt of the good or service is made, a charge may be made to the purchaser.

In another embodiment, in delivering goods and services to recipients, height and altitude of the smart marker can be varied to ensure optimum placement of the smart markers for people of varying heights as well as for people at different altitudes. Additionally, smart markers that are intended for an older audience, such as when distributing a smart marker for the purchase of liquor (e.g., beer from a business establishment co-located with the smart marker) may be directed to those who are viewing their augmented reality over a specific height, which roughly corresponds to the height of the user viewing the augmented reality.

### Advertising in Augmented Reality

In still another embodiment, a smart marker is placed within one or more augmented reality views that represents advertising. For instance, instead of selling a good or service through the exchange 302, the good or service is advertised for sale in augmented reality via smart marker. The smart marker may be location dependent or location independent. Other embodiments support the use of smart markers for distributing promotional advertising, such as those promoting a good or service.

In one embodiment, a smart marker representing advertising, promoting goods or services or for the direct sale of goods and services, displays with visual location cues like other smart markers in the various augmented reality/map/list views. The digital representation of the smart marker actually sits in its defined location in digital space, and is viewable when the user enters a defined space around the location (e.g., within a one-mile radius). For instance, the exclamation point “!” is shown as a smart marker 412. This smart marker 412 may provide access to the user to view for purchase a good that is being proffered for sale by a business in the building 414 located where the smart marker 412 is positioned in augmented reality view 402. Upon selection of the smart marker 412, the user is able to view and possibly purchase the good. For instance, the smart marker 412 may provide a link to the exchange 302 to facilitate completion of the transaction.

In another embodiment, a smart marker 416 representing advertising, promoting goods or services or for the direct sale of goods and services, can be displayed without visual location cues. For instance, a corresponding smart marker 416 appears in a corner of the mobile device screen. The digital representation of the virtual good is not tied to a defined location and is displayed when a region of interest for targeted advertising.

The user has the ability to control frequency, volume, and distance range of smart markers in advertising, representing goods and services, that appear as well as identify their own preferences categories of those smart markers. These preferences can be controlled dynamically by an on-screen slider to increase or decrease volume of displayed goods and services, or can be controlled from a separate tab. For instance, the user has the ability to control how much time virtual goods are displayed before they disappear from his or her view. In addition, the user may specify that smart markers advertising goods and services have a unique shape or color. A running history of advertising smart markers can be displayed over a designated period of time and can be accessed in a list view at any time.

### Electronic Payment Gateway

Businesses can also provide additional features to incorporate into their smart markers. For instance, these could include payment gateways providing customers to access funds exchange interfaces, merchandise display scripts, or user traffic information to complete and analyze business transactions through their custom smart markers.

In one embodiment, an electronic funds exchange can be utilized by users in the network, in accordance with one embodiment of the present invention. The electronic funds exchange facilitates the completion of transactions between a buyer and seller conducted through the augmented reality distribution network by facilitating the transfer of funds between the buyer and the seller. In particular, banking, credit card, point system, or other financial information can be stored within the secure profiles of the individual users participating in the augmented reality distribution network. Electronic funds transactions are facilitated through interaction with a location-based smart marker, in one implementation.

In one embodiment, the electronic funds exchange provides a complete service for the electronic transfer of funds. That is, the electronic funds exchange is capable of creating a monetary system (e.g., point system), storing points for parties, and transferring points between parties to effect the completion of a transaction.

In another embodiment, the electronic funds exchange works closely with third party financing companies (e.g., banks, credit card companies, etc.) to effect the electronic transfer of funds. For instance, transactions can be sponsored by institutions such as banks that allow their own customers to link their checking accounts to this electronic funds transfer system and allow controlled usage much like a debit card.

In still another embodiment, smart markers allow access to the payment gateway, and are located in association with a participating retailer. Customers can walk into stores and conduct transactions using the virtual smart marker for that store, or someone walking down the street can see an artist's painting in a park and buy it on the spot and have it delivered to their home.

As such, smart markers having location-based associations with businesses, individuals, vending machines, ticketing allow any monetary transaction to occur by interacting with the smart marker. A smart marker can allow a user to purchase goods and services entirely through the augmented reality distribution network. For instance, accessing a virtual smart marker on a mobile device can bring up a description of the available goods/services or allow for the user to enter a monetary amount and designate a recipient for purposes of delivery.

In addition, the smart marker provides for completing the transaction using the payment gateway to transfer funds in a secure, quick, and easy manner. As examples, funds are transferred through a server-based system, or any other secure data transfer method (Wi-Fi, Cellular, RFID, IR, etc). As such, a smart marker representing a payment gateway indicates to a user that the participating retailer is able to transfer funds for the purchase of goods or services through that retailer as supported by the augmented reality distribution network.

Also, the payment gateway facilitates the completion of a transaction when purchasing actual goods. For instance, a customer can walk into a store (e.g., grocery store), gather items, and purchase those items through a payment gateway. A built-in code scanner in the mobile application is able to scan codes (such as bar or QR) to determine pricing on goods or services. As such, a customer/user is able to physically scan the products intended for purchase. Rather than using a traditional check-out mechanism, the total cost of all the items or services selected is totaled and displayed as a code. That code can be scanned by the participating business or used by the user to complete the transaction in the payment gateway. For instance, the code provides information to access and transfer funds from the buyer to the seller. Confirmation of the funds transfer, including the total, is automatically sent to the user's mobile device based on proximity, or upon presentation of a unique code identifier.

Additionally, by using the QR code to facilitate purchase of goods and service, information related to the purchase may be stored for later analysis, and used for various purposes, such as rewards programs, tracking history of purchases and returns, etc. For instance, information related to the use of the QR code can be used to track a user's purchases at a business to build up a history of the user's transactions. In addition, information related to the QR code can be used to track a user's purchases at a plurality of businesses to build a history of the user's purchase transactions. In addition, information in the history can be used to implement a rewards program, in which discounts or gifts of free items can be used as rewards back to the user, after a certain level of purchases are met. Moreover, this information related to the use of the QR code may be used to track a history of purchases for returns or exchanges. As such, the use of the unique smart marker for corresponding business in conjunction with the use of the QR code allows for the implementation of rewards programs and tracking transaction histories of users.

### Smart Marker Location Indicator

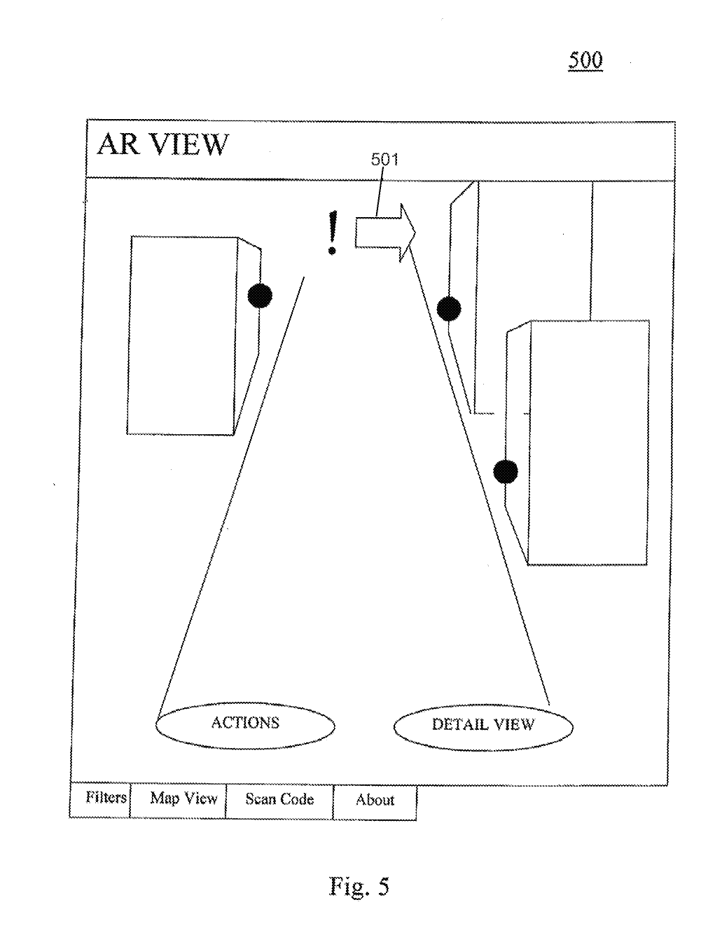

FIG. 5 is an illustration of an augmented reality view 502 of a smart marker locator 501 indicating a location of a smart marker, in accordance with one embodiment of the present invention. The smart marker locator 501 may indicate that a good or service is waiting for the user. The smart marker locator 501 or directional finder helps locate smart markers even if the mobile device providing a live view is not pointing directly at the location of the smart marker, as provided in augmented reality. In addition, the smart marker locator 501 may help find smart markers initially selected from a map or list view, upon transition to an augmented reality view.

For example, the delivery of a good or service is effectuated through a smart marker. A smart marker locator 501 or directional finder can be located in the augmented reality view, or provided independently of the augmented reality view (e.g., outside of the border of the augmented reality view). The smart marker locator 501 indicates in which direction a user needs to turn in order to find the selected smart marker. The smart marker locator 501 can be an arrow or any shape that lets the user know which direction to turn. Turn-by-turn directions can be overlaid in the augmented reality view 502 to supplement the smart marker locator 501. The augmented reality view 502 can also automatically display the smart marker locator at the optimal size on the mobile device even if the user is not within the vicinity of the selected smart marker. This allows the user to experience the content or functionality housed within the selected smart marker without having to be physically next to the selected smart marker.

For example, FIG. 5 provides an illustration of a smart marker locator 501 pointing to the right, in accordance with one embodiment of the present invention. In this case, a smart marker is located within the vicinity of the user, but out of the augmented reality view 502. In addition, the smart marker is located in a direction to the right in the augmented reality view 502, such as down the street and to the right.

Also, a smart marker locator 501 can also move dynamically up and down the screen to indicate at what height the selected smart marker is located. Further, the smart marker locator 501 disappears after the smart marker appears in the augmented reality view 502 of the device.

Systems and methods for the purchase and delivery of goods and services, virtual and real, and a payment gateway in an augmented reality distribution network in an augmented reality-enabled distribution network are thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

We claim:

1. A computer implemented method for providing purchases in an augmented reality, the computer implemented method comprising:
providing an augmented reality to a participant, said augmented reality including a smart marker representing an exchange, said smart marker having an interactive zone;
receiving a notification that said participant is within said interactive zone; and
providing a notification to said participant indicating a presence of said exchange.

2. The computer implemented method of claim 1, the computer implemented method further comprising:
receiving a request from said participant for a purchase of an item within said exchange; and
facilitating the purchase of said item through a payment gateway.

3. The computer implemented method of claim 2, wherein said item is selected from the group consisting of a physical good, a physical service, a virtual good, and a virtual service.

4. The computer implemented method of claim 1, the computer implemented method further comprising:
receiving an input indicating a selection of said smart marker; and
providing information to said participant relating an item available for purchase within said exchange.

5. The computer implemented method of claim 1, the computer implemented method further comprising:
receiving an input indicating a selection of said smart marker; and
providing information to said participant relating a means for accessing said exchange.

6. The computer implemented method of claim 5, wherein said means for accessing said exchange includes providing a uniform resource locator.

7. The computer implemented method of claim 1, wherein said smart marker is located within the augmented reality at a location corresponding to a physical location of a merchant.

8. The computer implemented method of claim 7, wherein said exchange includes items sold by said merchant outside of said augmented reality.

9. The computer implemented method of claim 1, wherein said smart marker is at a location within the augmented reality at a location corresponding to a point of interest.

10. The computer implemented method of claim 9, wherein said exchange contains items related to said point of interest.

11. The computer implemented method of claim 10, wherein said items related to said point of interest are provided by a plurality of merchants.

12. A computer program product for implementing a method for making purchases in an augmented reality, the computer program product comprising one or more computer readable storage media having stored thereon computer executable instructions that, when executed by one or more computing processors of a computing system, cause the computing system to perform the method, the method comprising:
providing an augmented reality to a participant, said augmented reality including a smart marker representing an exchange, said smart marker having an interactive zone;
receiving a notification that said participant is within said interactive zone;
providing a notification to said participant indicating a presence of said exchange;
receiving a request from said participant for a purchase of an item within said exchange; and
facilitating the purchase of said item through a payment gateway.

13. A computer implemented method for making purchases in an augmented reality, the method comprising:
determining a location of a user;
displaying an augmented reality, said augmented reality based on said location of said user and including a smart marker representing an exchange, said smart marker being associated with said location of said user;
receiving a user input indicating the selection of said smart marker; and
displaying information associated with said exchange to said user.

14. The computer implemented method of claim 13, wherein said information includes a list of items available at said exchange, the method further comprising:
receiving a user input selecting an item from among said list of items available at said exchange; and
facilitating the purchase of said item through a payment gateway.

15. The computer implemented method of claim 14, wherein said item is selected from the group consisting of physical goods, virtual goods, physical services, and virtual services.

16. A computer program product for implementing a method for making purchases in an augmented reality, the computer program product comprising one or more computer readable storage media having stored thereon computer executable instructions that, when executed by one or more computing processors of a computing system, cause the computing system to perform the method, the method comprising:
determining a location of a user;
displaying an augmented reality, said augmented reality based on the location of the user and including a smart marker representing an exchange, said smart marker being associated with said location of said user;
receiving a user input indicating a selection of said smart marker;
displaying information associated with said exchange;
receiving a user input selecting an item from among said list of items available at said exchange; and
facilitating the purchase of said item through a payment gateway.

17. A system for making purchases in augmented reality, the system comprising:
a server supporting the presentation of information within augmented reality of a plurality of participants;
a communication network for facilitating the transfer of information from said server to devices of said plurality of participants;
a purchase and delivery exchange facilitating the sale of goods and services deliverable through augmented reality.

18. The system of claim 17, further comprising:
a payment gateway facilitating the transfer of funds between a buyer and seller in association with a transaction conducted through the purchase and delivery exchange.

19. A system for making purchases in augmented reality, comprising:
a server supporting a presentation of information within augmented reality of a plurality of participants;
a communication network for facilitating a transfer of information from said server to devices of said plurality of participants;
a smart marker facilitating a sale of a good or service deliverable through augmented reality.

20. The system of claim 19, the system further comprising:
a payment gateway facilitating a transfer of funds between a buyer and seller in association with the sale of said good or service.
